(19) United States
(12) Patent Application Publication
(10) Pub. No.: US 2006/0192044 A1
(43) Pub. Date: Aug. 31, 2006

(54) Deep water fishing rod and electric reel

(76) Inventor: Peter B. Lindgren, Pompano Beach, FL (US)

Correspondence Address: MCHALE & SLAVIN, P.A., 2855 PGA BLVD, PALM BEACH GARDENS, FL, 33410, US

(21) Appl. No.: 11/355,911

(22) Filed: Feb. 16, 2006

Related U.S. Application Data
(60) Provisional application No. 60/654,386, filed on Feb. 17, 2005.

(51) Int. Cl. A01K 89/02

(52) U.S. Cl. 242/291; 43/24; 43/20

(57) ABSTRACT

The instant invention is a deep water fishing rod and reel system. The fishing rod employs a substantially flat wishbone structure that eliminates the need for guides along the length of the rod by allowing the fishing line to between two elongated members that constituted the rod during flex conditions, such as when retrieving a fish. A swivel roller is placed at the distal end of the rod allowing fishing line from a reel to the swivel roller to pass unobstructed through the rod structure. An electric reel includes a cantilever spool having an enlarged interior allowing the fisherman to control free spooling by use of one or more fingers to frictionally engage the inner surface of the spool. A two stage drag system employs a first set of springs to allow free spooling with a hands off, minimal drag operation and a second set of springs for proper setting for the fish hauling.

### PRIORITY CLAIM

This application is claims a priority date of Feb. 17, 2005 based upon Provisional Patent Application No. 60/654,386, the contents of which are incorporated herein by reference.

### FIELD OF THE INVENTION

The field of the invention is related to fishing and in particular to a rod and electric reel for use in deep sea fishing.

### BACKGROUND OF THE INVENTION

Fishing in water depths between 300 and 2000 feet is known as deep water fishing. Deep water fishing is considered one of the most productive types of fishing due to the abundance of fish at these lower depths. However, the ability to fish in deep water requires speciality equipment that is expensive, complicated, and typically not usable by recreational fisherman.

The tactic of deep water fishing requires equipment capable of placing lures/bait at deep water depths and the ability to retrieve the fish that has taken the bait. As a boat cannot anchor in such depths, the need to weight a lure is necessary to reach the bottom as the boat drifts and/or currents move the lure. The higher the weight, the quicker the lure can be positioned. If a high wind is present, the boat may drift at a disproportionate rate to the bait. Further, if a boat is fishing in the Gulf Stream, the currents and winds seldom move in unison wherein a weight upwards of 30 lbs may be necessary to properly sink and maintain the bait at the proper depth. The need to free spool to the fishing site yet “feel” the bottom when the weight hits the sea floor is required for successful fishing. Further, the ability to withdraw the weight which is compounded by the weight of a fish, makes the use of conventional fishing gear impractical.

To address this situation, attempts have been made to use various types of power driven reels placed on devices that resemble a winch. Electric reels were driven from aircraft surplus 27 volt motors because of their low weight and good performance when attached to a drive 10/0 or 12/0 hand crank reel. Eventually these reels were replaced by commercial electric or specially built electric motors which were heavy and bulky. The use of 12 volt electric models were low on power when attached to a modify fishing reel. However, the use of higher voltage required a special power supply and typically could only be used on boats having 24 or 32 volt systems.

Hydraulic fishing reels were also used but required expensive systems and motors that employed moving valves that required high maintenance to inhibit corrosion caused by salt water use, even minimal corrosion resulted in failure of the the hydraulic motors.

Still another problem with deep water fishing is the ability to accurate estimate the length of line that has been deployed. This allows the fisherman to determine the depth of the bottom and, if the lure has not engaged the bottom, that additional weight is necessary to reach the desired depth due to bait drift.

Another problem with deep water fishing is that it relies upon a very large amount of line that must be controlled as it is directed over the side of a boat. While the use of a conventional fishing rod is preferred, a conventional fishing rod employs a plurality of guide tips. Guide tips introduce drag, the friction induced affecting the longevity of the fishing line. Even if all the guide tips included rollers, each time a line engages a roller can introduce a stress to the line. For instance, if the roller bearing has any corrosion, it can quickly generate friction that will affect line strength. Salt can collect on the outer surface of the roller creating imperfections that can Further, should the line break the conventional guide tips require threading of line which can be most difficult if a boat is subjected to sea movement during the threading.

### PRIOR ART

The use of fishing reels with counters is well known in the art. Counting devices are exemplified by the following patents: U.S. Pat. Nos. 4,697,758; 5,395,065; 5,503,341; 5,833,154; 6,053,443; 6,056,218; 6,126,103; 6,561,033; 4,934,628; 5,236,147; 4,620,371 and 4,634,072.

Fishing poles with quick mount guides are also known in the art and exemplified by the following patents: U.S. Pat. Nos. 2,855,717; 3,210,881; 3,403,468; 4,807,385; 4,209,931; 4,693,029; 3,060,618; 2,702,959; 1,964,631; 863,606; 814,321; 4,020,581; 6,802,151; 3,769,737.

U.S. Pat. No. 4,014,127 discloses a heavy duty fishing reel designed to retrieve heavier weights such as that used in deep water fishing. This device includes a hand crank and a tackle mechanism which denies the fisherman use of the conventional style rod which is time proven to give the most control to the fisherman. Control of lure placement and fish retrieval is a mainstay of recreational or sport fishing.

Current technology is to modify conventional fishing rods or booms for deep sea fishing. However, modification of conventional fishing equipment can not address the aforementioned problems due to inherent limitations such as the need for a plurality of guide rollers. Further conventional fishing rods are traditionally made from fiber glass rods or composites thereof. Down riggers may consist of a rod having a stretch rope pivoting on a boom. The end of the rod will have a pulley placed underneath the rod which is wasteful in vertical height and does not provide ready access for retrieving fish. Finally, because deep water electric reels and rods are larger than most hand cranks, they will not fit in a standard rod and reel storage holder. For this reason, the rod is usually disconnected from the reel to make storage easier, the end of the line removed to take the line through the rod line guides.

### SUMMARY OF THE INVENTION

Disclosed is a deep sea fishing rod and reel that employs a reel butt adapted for holding a fishing reel, the rod is wishbone shaped formed from a first elongated member with a proximal end, a distal end and a length therebetween and a second elongated member having proximal end, a distal end and a length therebetween. The proximal ends of the elongated members are connected to the reel butt and the distal end of the first elongated member connected to said distal end of the second elongated member with the lengths between the first and second elongated members spaced apart. A swivel guide is positioned at the distal end of the elongated members for directional placement of a fishing line between the proximal end and the distal end of the elongated member.

A reel main body secured to the rod butt, the reel body having a spool drive shaft with a cantilevered spool rotatably secured to the spool drive shaft. The cantilevered spool has an inner surface and an outer surface, the inner surface sized to receive the fisherman's fingers to permit manual braking of the spool through frictional engagement. The outer surface of the cantilevered spool is adapted to receive a fish line thereon wherein the cantilevered spool is rotatably secured to said reel main body allowing spool removal without disassembly of the fish line.

The deep sea fishing reel includes a first set of engaging springs sized to permit light drag to allow free spooling, and a second set of engaging springs for fish hauling. The first set of engaging springs induce a light drag and the second set of engaging springs induce a heavy drag, the second set of engaging springs providing secondary engagement to the first set of engaging springs. The fishing reel is driven by an electric drive motor having a counter to determine length of line deployment and ease of retrieval. A swivel guide couples to the distal end of the fishing rod. The swivel guide allows removal of the fishing line without removal of end line tackle.

An objective of the instant invention is to disclose a deep water rod and reel that is economical, employs a rod capable of eliminating guide tip stress, and employs a two stage drag system for free spooling and fish retrieval.

Still another objective of the instant invention is to provide a spool design that allows a fisherman to control spooling through fingertip engagement of the inner surface of the spool.

Yet another objective of the instant invention is to provide a cantilever spool design that allows for quick spool change for replacement of lines or line types.

Another objective of the instant invention is to provide a two stage drag system that has a first set of engaging light springs to allow free spooling with hands off operation with a very light drag and a second stage drag engaging after the first stage for proper setting for fish hauling.

Another objective of the instant invention is to teach a cantilevered level winder allowing for an unobstructed handling of the free end of a cantilevered spool.

Still another objective of the instant invention is to provide a wishbone rod design with an over center rod swivel tip.

Still another objective of the instant invention is to provide a swivel tip thread with a guide bar so that line can be removed from the rod without removing the end tackle.

Yet another objective of the invention is to provide a cantilevered level wind allowing a fisherman to remove the spool, fishing line, and end tackle without disassembly of the fishing line.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is a perspective view of the fishing rod and reel of the instant invention;

FIG. 2 is an perspective view of the rod shown in FIG. 1;

FIG. 3 is an enlarged view of the swivel rod tip shown in FIG. 1;

FIG. 4 is a perspective view of the swivel rod tip of FIG. 3;

FIG. 5 is a perspective view of the fishing rod and electric reel;

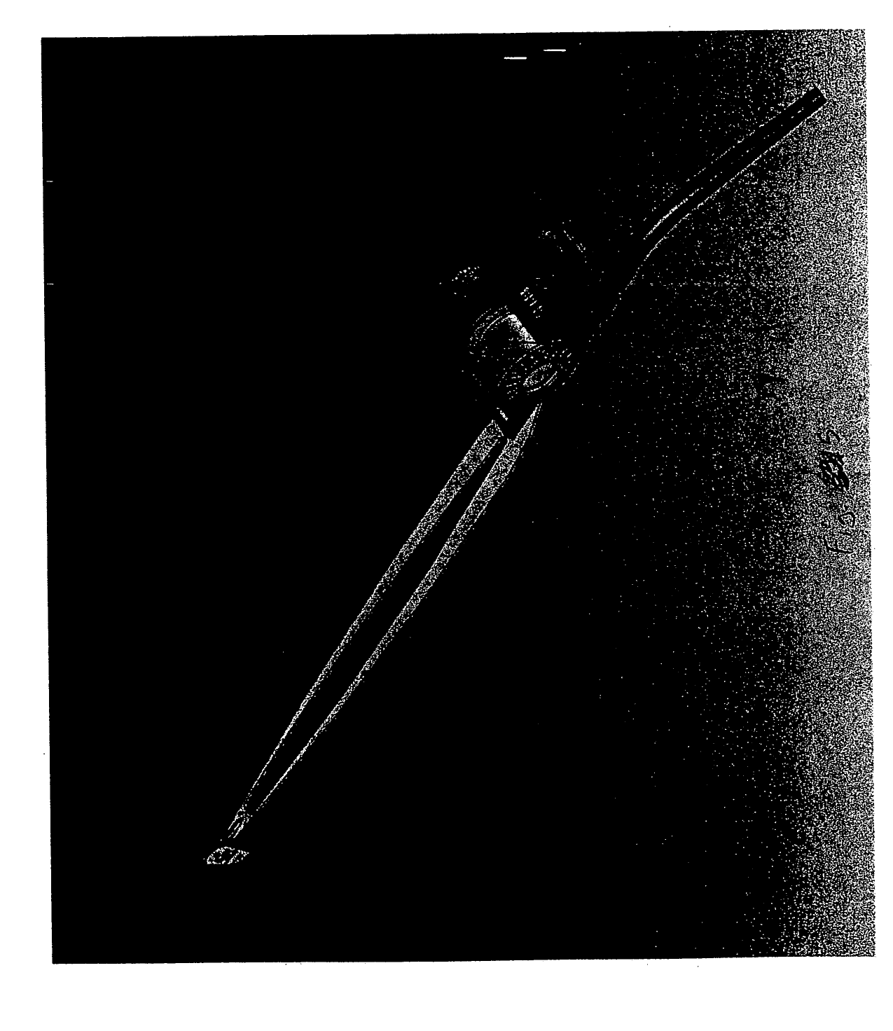

FIG. 6 is a perspective view of the fishing reel;

FIG. 7 is a cross section of fishing reel;

FIG. 8 is a cross sectional pictorial view of the gearing mechanism of the fishing reel in FIG. 6;

FIG. 9 is an enlarged side view of the drive spur;

FIG. 10 is an exploded view of the gears for the drive mechanism;

FIG. 11 is an exploded view of the drive mechanism and level winder; and

FIG. 12 is a side view of the drive mechanism.

### DESCRIPTION OF THE INVENTION

Now referring to the Figures, set forth is the fishing rod 10 of the instant invention defined at one end by a rod holder butt 12 and at the opposite end by a swivel guide tip 14. The rod 10 further includes a flexible rod portion 24 defined by a proximal end 16 and distal end 18 formed into a wishbone shape having minimum thickness. The flexible rod portion 24 includes a first elongated member 15 having a proximal end 17, a distal end 18 forming a length therebetween. A second elongated member 19 has a proximal end 21, a distal end 23 forming a length therebetween. The proximal ends 17 and 21 of the elongated members are connected 16 to the reel butt 12. The distal end 18 of the first elongated member 15 is connected to the distal end 23 of the second elongated member 19 along end section 14 whereby the elongated members 15 and 19 are spaced apart forming an opening 20. A fishing guide means 22 is positioned at the distal ends 14 of the elongated members for directional placement of a fishing line between a fishing reel mounted on the reel butt, shown in various drawings, and the fishing guide means 22. The rod portion formed into the wishbone shape as defined by a centrally disposed opening 20 is preferably formed by a flat rod constructed from titanium, aluminum alloy, aluminum flat bar, injection molded plastic, plastic filled with glass, carbon fiber, combination of glass and carbon fiber, or the like that allows flexibility along one plane. A swivel guide tip 22 is removably mounted at the distal end 14 of the rod structure 24 which permits directional tracking of fishing line as it is spooled or retrieved from a spool. The wishbone shape is illustrated by a flat bar elongated member 15 having a proximal end 17 having a first width and a distal end having a second width 18, the first width wider than the second width.

When the rod structure 24 is in a passive condition, fishing line from a spool mounted on the reel to the extends above the opening 20. When the rod structure 24 is working, such as when a high load is placed on the assembly due to fish retrieval, the rod structure 24 will bend in a similar fashion as a conventional fishing pole. However, in the instant invention, the fishing line will extend through the opening 20 following a straight line between the spool and the rod tip, the opening 20 allowing a straight line passage. This eliminates the problem of conventional rods that require a plurality of guides to maintain the fishing line. Further, the higher the loading on the line, the higher the pressure on the guide tips all of which leads to early line failure. The removal of guides eliminates any friction that could be caused thereby and the guide tip maintains the line in a centrally disposed position during high loading.

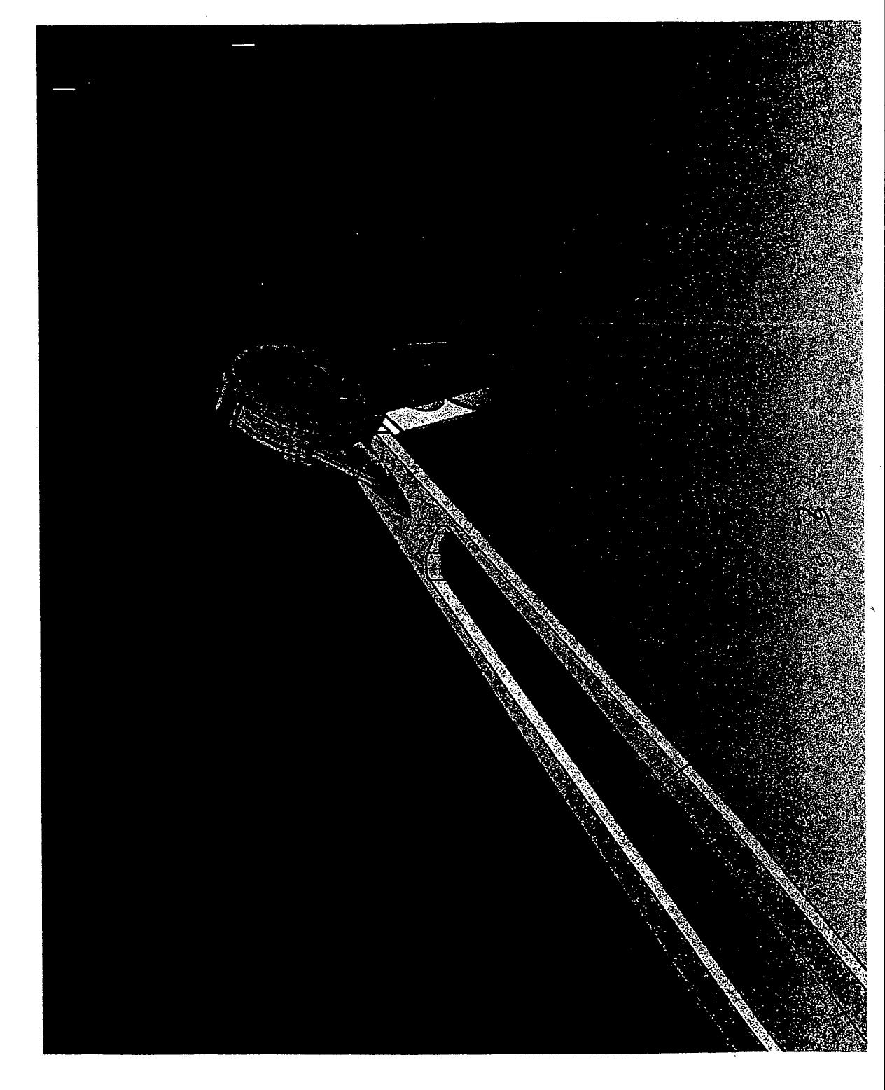

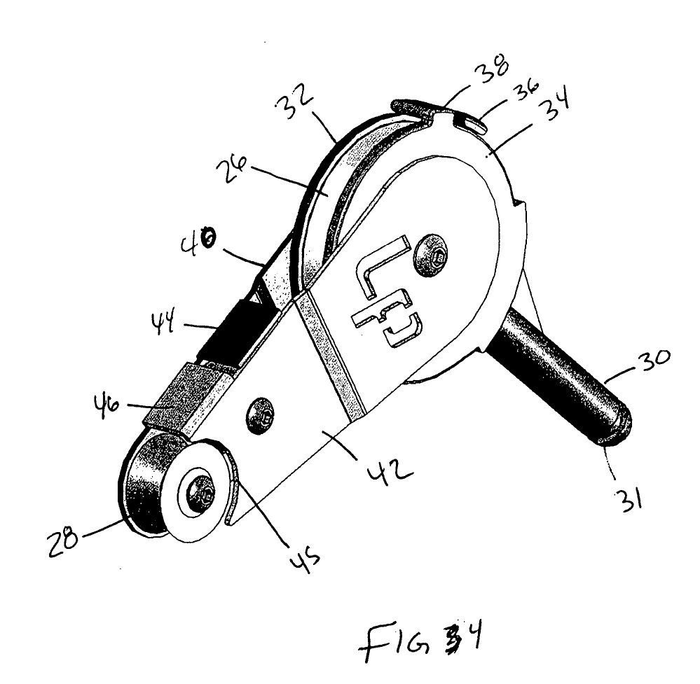

FIGS. 3 and 4 depict the fishing guide means or swivel guide tip 22 which basically consists of rollers 26 and 28. When a line wraps around the upper roller 26, it is positioned for passage over lower roller 28. A swivel insert 30 allows for quick disengagement of the rod tip for storage or replacement. An inset end 31 of the swivel insert 30 if formed by a recess that permits frictional engagement of the receiver end on the fishing rod. The inset end 31 is operatively associated with an engaging prong, not shown, located on the inside of the rod end. The inset end is an illustration of a preferred embodiment but is not limited to the various frictional engagement mechanisms that can be substituted. a The swivel tip can be quickly changed if different line sizes are employed with the insert 30 functioning as a pinion to maintain the fishing line in proper alignment with the line end tackle at all times.

Sidewalls 32 and 34 secure upper roller 26 with spaced tabs 36 and 38 which allows the line to be snaked through the tabs for placement onto the roller. Similarly, sidewalls 40 and 42 include spaced tabs 44 and 46 which allow the line, not shown, to be snaked through around the tabs for placement over the lower roller 28.

The swivel insert 30 is coupled to the first grooved upper roller 26. The first grooved upper roller is for receiving of a fishing line from a spool mounted on the fishing rod. The first grooved upper roller allows the fishing line to rotate about an axis substantially perpendicular to axis plane of the fishing rod. The first grooved upper roller includes a first tab 36 coupled perpendicular to an edge of a first side wall 32 and extending over the grooved roller 26. A second tab 38 coupled perpendicular to an edge of a second side wall 34 and extending over the grooved roller 26. The first tab 36 is offset and spaced apart from the second tab 38 whereby a fishing line can be placed between the tabs to allow engagement with the grooved roller.

A second grooved roller 28 is secured to the swivel insert 30 and spaced apart from the first grooved roller 26 by a first bracket sidewall 40 and a second bracket sidewall 42. The second grooved roller 28 includes a first bracket tab 44 formed perpendicular to an edge of said bracket first side wall 40. A second bracket tab 46 formed perpendicular to an edge of a bracket second side wall 52. The first bracket tab 44 is offset and spaced apart from the second tab 46 whereby a fishing line can be placed onto the second grooved roller 28 by placement of the line through the spaces formed by the bracket tabs. The bracket first side wall 52 provides support for the roller 28 with the bracket second side wall 42 having a end edge 45 that allows access to roller 28 for ease of removal, changing of rollers to allow various roller line grooves to handle different line sizes, as well as access to all areas of the second roller 28 should line tangling or debris interference takes place. The swivel tip allows removal from the rod without the need for removing line end tackle.

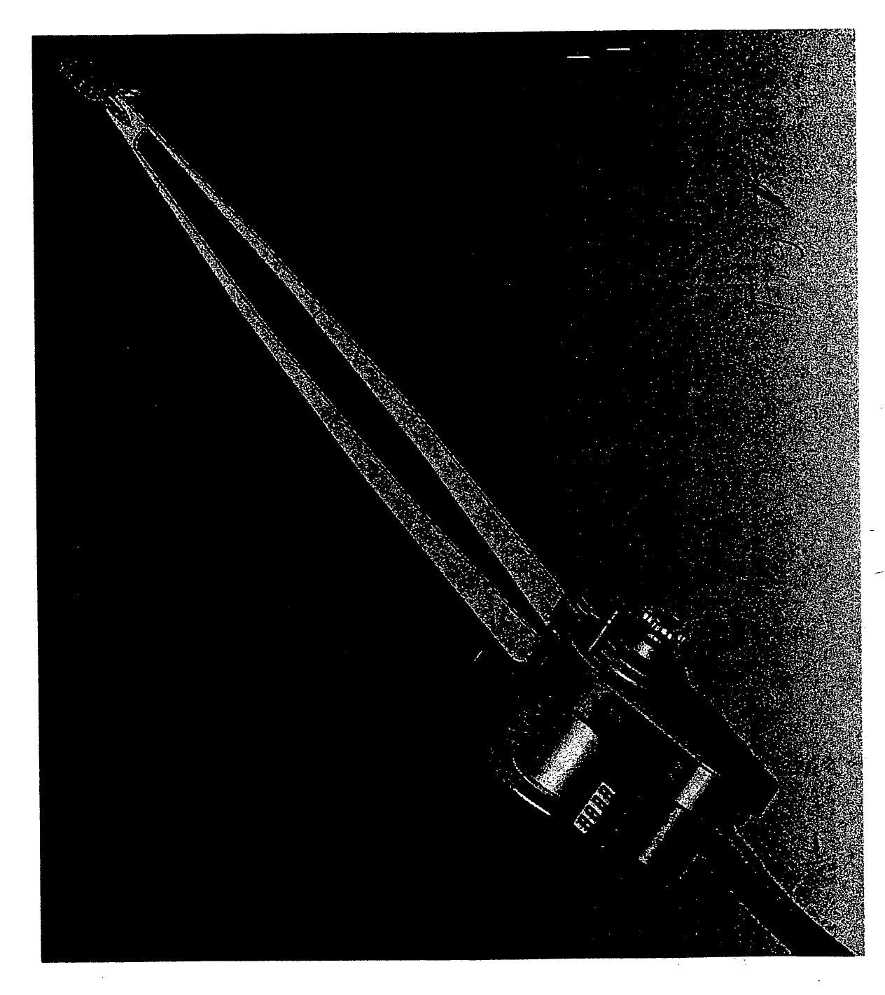

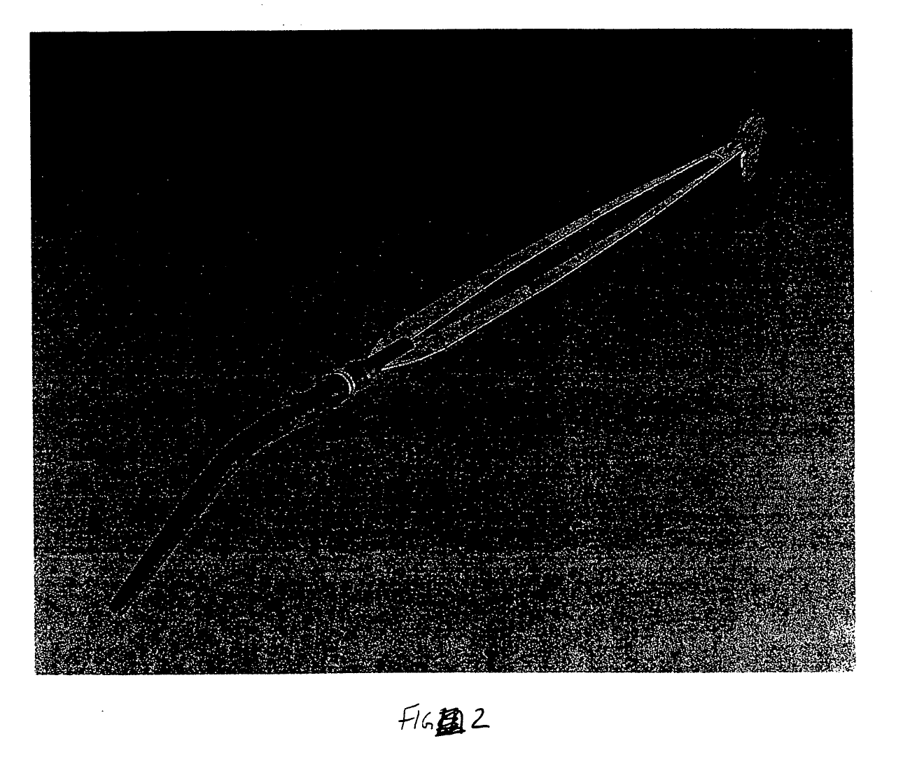

FIGS. 1-3 depicts the wishbone rod 24 with swivel tip 22 and butt 12. In this illustration, electric reel 50 is shown mounted to the rod. The reel having a control panel and display 52, a cantilever spool 54 and a drag lever 56. Line is wrapped around the cantilever spool 54 along the upper surface 58. An inner surface 60 allows for hand insertion of the fisherman to control free wheeling of the spool wherein the hand can be used as for braking. The hand providing sensory touch to determine when free wheeling must stop which can be felt though the fingers. Instant stop of free wheeling will prevent over spooling and associated line tangling. During rewind, a lever winder 62 prevents proper trapping of the line over the spool 54. The spool 54 is rotatably secured to a spool drive shaft extending from the main body of the reel 50.

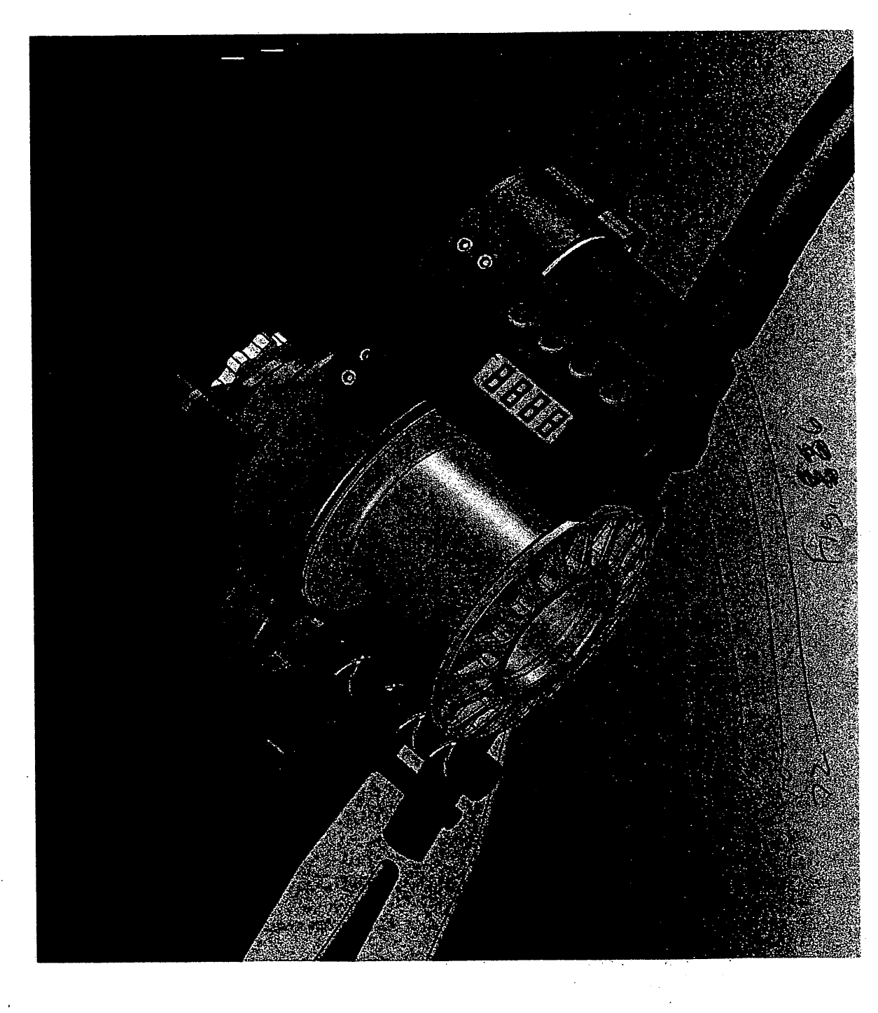

FIG. 6 is an enlarged view of the electric reel 50 showing the display panel 52 with the memory line counter 64. The display panel 52 includes a series of switches to control a microprocessor. Switch 66 turns the unit on, switch 68 provides an off condition. Switch 70 zeros out the line counter and switch 72 can be used to set the line stop.

The cantilever spool 58 includes an enlarged center section 60 for placement of the operator's hand and ease of access for quick disconnect. Replacement of the spool can then be performed quickly should a separate or different line be required. This further allows for removal of the spool with fishing line and lure attached. For instance, if a line becomes tangled and the fisherman is desirous of saving the rigging, the spool, line, and rigging can be quickly removed and replaced. Further, spools with lines can be prerigged during non-fishing times, such as on shore, wherein a rod and reel can be customized to the fish and sea conditions with minimal effort.

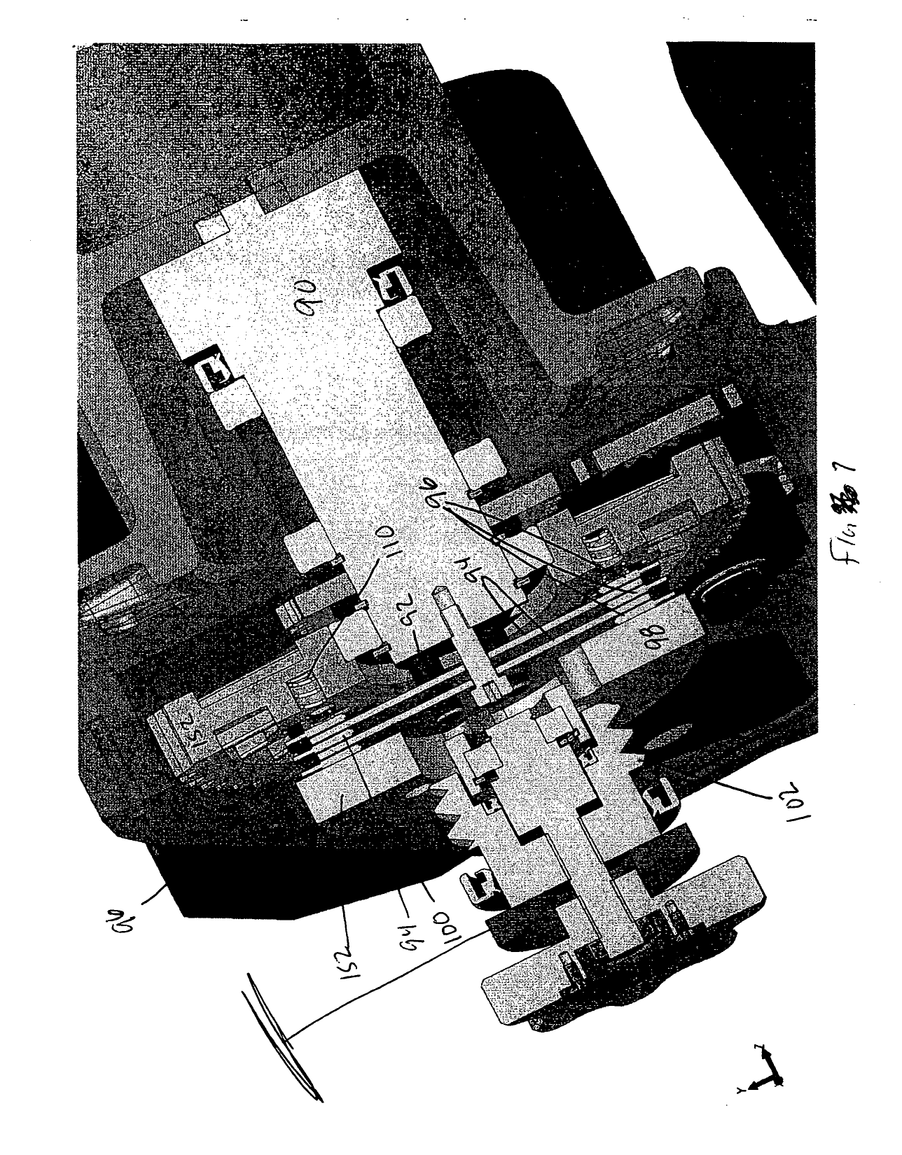

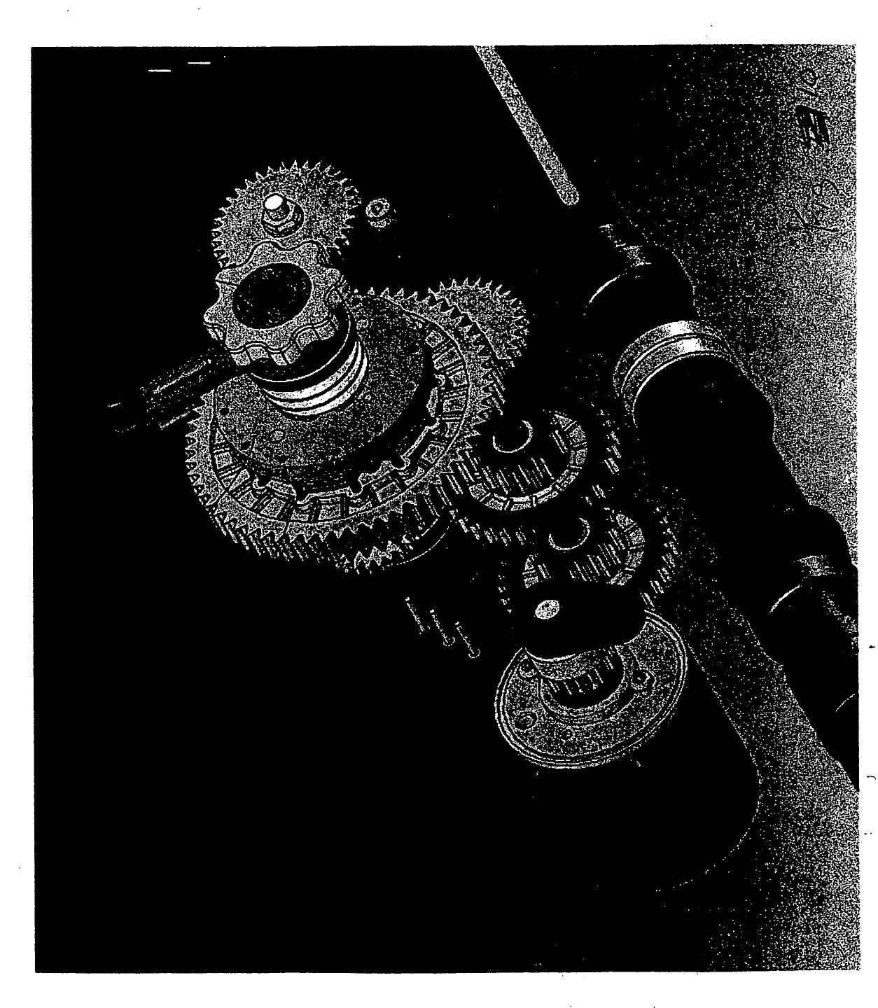

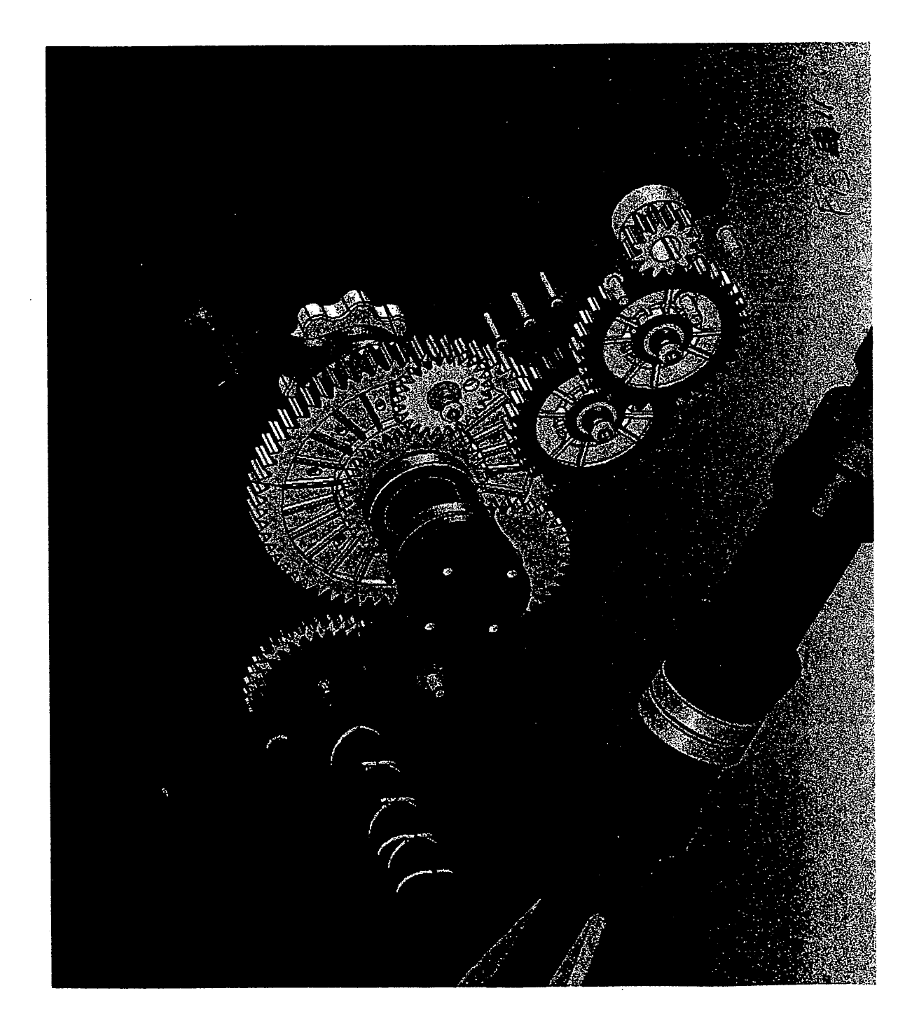

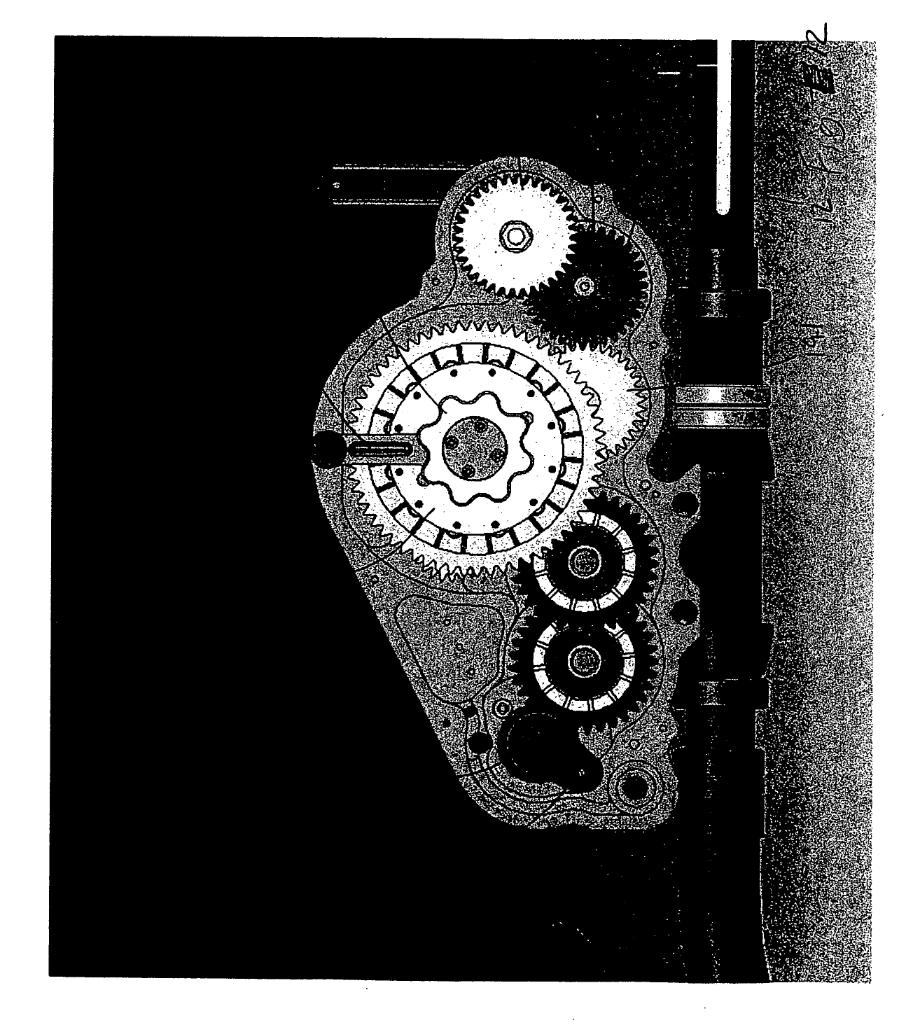

Referring now, in general, to FIGS. 7 through 12 set forth is the operating mechanism of the instant reel. The reel includes main shaft 90 shown with shaft pins 92. A plurality of flat plate drives 94 with sintered bronze drag plates 96 are used for drag. A drive spur 98 is couple with drive spur pins 100. Drag advance threads are depicted by numeral 102. The spool drive shaft 90 is coupled to a drive gear 152, the drive gear having a first set of engaging springs 110, the first set of engaging springs 110 sized to permit light drag to allow free spooling of the spool. The drive gear 152 includes a second set of engaging springs 112 that provides for fish hauling. The two stage drag system permits free spooling with hands off operation with a very light drag by use of the light spring and the second stage drag engaging after the first stage for proper setting for fish hauling. The first set of engaging springs induces a light drag and the second set of engaging springs induces a heavy drag. The second set of engaging springs providing secondary engagement to the first set of engaging springs.

Deep water bottom fishing requires attention by the operator to keep the reel from backlashing while free spooling, as well as to sense the bottom when the lure/bait touches bottom to immediately stop additional free reeling before slack line causes tangling, kinking and prevents fish strike sensitivity. This is typically performed by pressing slightly on the inner surface of the spool with at least one digit (finger) of individual while in free spool allowing the fisherman to sense the speed and bottom impact. Preferably the fisherman will place a three or four digits within the spool to cause the proper braking.

The main drive shaft 90 which is maintained in position by use of drive bearings 106. The drive plates 94 are biased by low 110 and high drag setting springs 112. The main drag threaded adjuster is depicted by numeral 102 with drag lever main adjuster depicted with numeral 112. The fine tuned drag threaded adjuster 114 operates in conjunction with the drag fine tune knob 116.

The reel operates in a two stage drag system wherein the first set of engaging light springs 110 allows for free spooling with hands off operation providing a very light drag. The second set of high setting drag springs 112 engage after the first stage for proper setting to allow fish hauling.

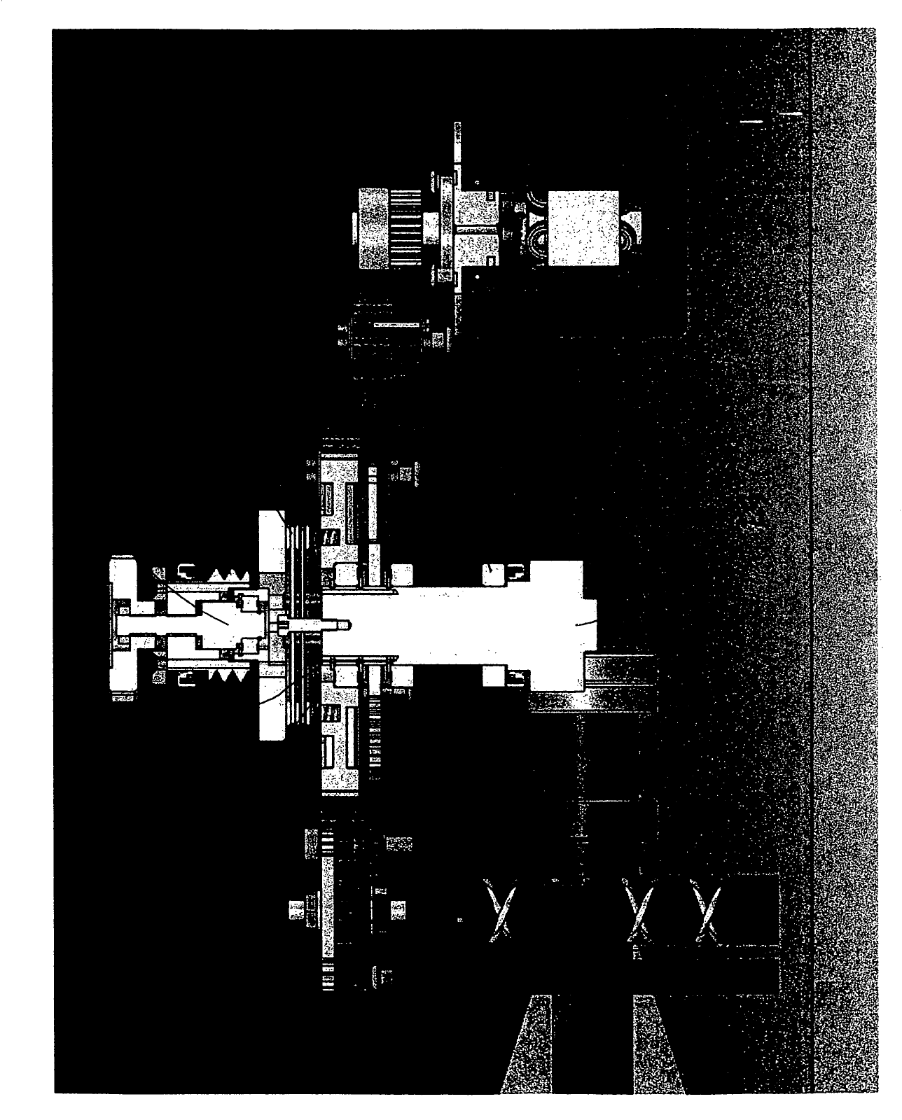

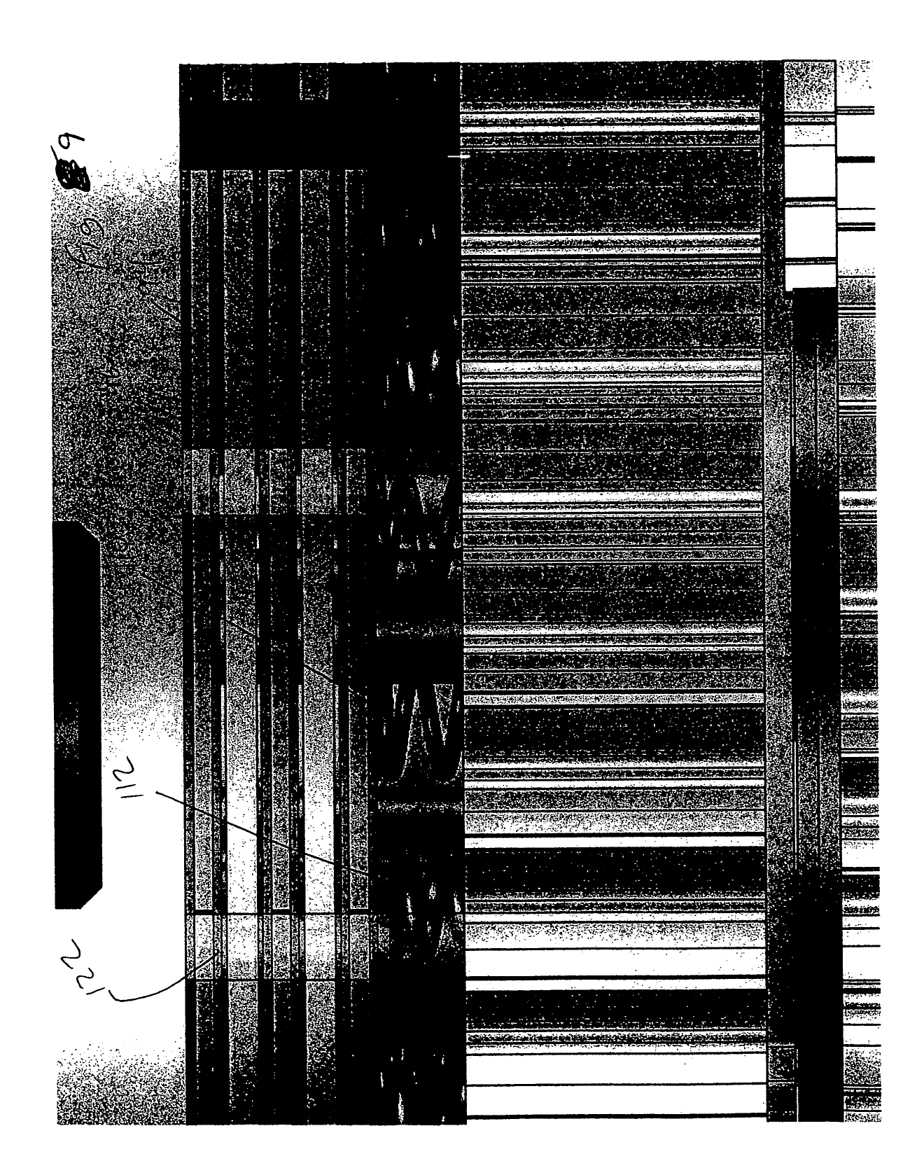

FIG. 9 provides an enlarged view of the high setting drag springs 112 and low setting drag springs 110. The sintered bronze drag plates 96 are interposed with flat friction disc 94. The drive motor 130 further shown in FIG. 8 is preferably a 12 volt brushless D.C. motor which allows operation in most recreational vessels which typically employ a 12 volt charging system. However, it should be noted that various voltages can be provided including 24V and 36V which allows for smaller motor design.

An anti reverse torque lever 140 in conjunction with a anti reverse gear or alternatively a one way bearing 150. The main drive gear 152 works in conjunction with the drag drive spur 120. The drag control lever handle 154 is depicted with the drag lever 156. The fine adjustment 160 provides the drag limit adjustment. The main drive gear 152 which is the used with a counter drive gear 180. The gears couple to the lever winder 182 though compound gears 184 for transfer of torque. The lever winder 186 includes a grooved shaft that allows for movement of a directional spool for placement of line around the storage spool. The lever winder is cantilevered by use of the level wind anti-rotation support bar 192 which allows the level winder guide 190 to slide along the support bar 192 by following the track of the level winder diamond shaft 186 providing directional positioning of fishing line on to the outer surface of the cantilevered spool. As shown in FIG. 21, the lever winder compound gears 184 are shown for coupling to the lever winder. Further depicted is a guide bar support for the lever winder numeral 190. A first compound gear 191 is rotated in response to the main drive gear 152, the first compound gear 191 drives a second compound gear 193 having a step down sprocket 195. The step down sprocket 195 drives a third sprocket 197 causing rotation of the level winder diamond shaft 186 and movement of the level winder guide bar 190 in relation thereto.

It is to be understood that while I have illustrated and described certain forms of the invention, it is not to be limited to the specific forms or arrangement of parts herein described and shown. It will be apparent to those skilled in the art that various changes may be made without departing from the scope of the invention and the invention is not to be considered limited to what is shown in the drawings and described in the specification.

What is claimed is:

1. A fishing reel having a cantilevered spool comprising:
a reel main body having a spool drive shaft; a cantilevered spool rotatably secured to said spool drive shaft, said cantilevered spool having an inner surface and an outer surface, said outer surface adapted to receive a fish line thereon, said inner surface sized to receive at least two digits of a human hand to permit spool braking; said cantilevered spool is rotatably secured to said reel main body and removable therefrom without disassembly of the fish line.

2. The deep sea fishing reel according to claim 1 wherein said spool drive shaft is coupled to a drive gear, said drive gear having a first set of engaging springs, said first set of engaging springs sized to permit light drag to allow free spooling.

3. The deep sea fishing reel according to claim 2 wherein said said drive gear includes a second set of engaging springs for fish hauling.

4. The deep sea fishing reel according to claim 3 wherein said said first set of engaging springs induce a light drag and said second set of engaging springs induce-a heavy drag, said second set of engaging springs providing secondary engagement to said first set of engaging springs.

5. The deep sea fishing reel according to claim 1 including a cantilevered level winder means providing directional positioning of fishing line on said outer surface of said cantilevered spool, said cantilevered level winder allowing removal of fishing line without disassembly.

6. The deep sea fishing reel according to claim 1 wherein said spool drive shaft coupled to an electric drive motor means.

7. A fishing rod comprising:
a reel butt adapted for holding a fishing reel;
a first elongated member having a proximal end, a distal end and a length therebetween;
a second elongated member having proximal end, a distal end and a length therebetween spaced apart from said first elongated member;
said proximal ends of said elongated members connected to said reel butt, said distal end of said first elongated member connected to said distal end of said second elongated member; and
a fishing guide means positioned at said distal end of said elongated members for directional placement of a fishing line between said proximal and distal ends whereby the fishing line

8. The fishing rod according to claim 7 wherein each said elongated member is wishbone shaped defined as having said proximal end sized of a first width and said distal end sized of a second width, said first width wider than said second width.

9. The fishing rod according to claim 7 wherein each said elongated member is substantially flat whereby flexion is limited to upward and downward movement.

10. The fishing rod according to claim 7 wherein said fishing line guide means is a swivel insert available for coupling to said distal end of said elongated member, said swivel insert having a first grooved roller secured to said swivel insert, said first grooved roller for receiving of a fishing line from said fishing rod to rotate about an axis substantially perpendicular to said fishing rod; and
a second grooved roller secured to said swivel insert and spaced apart from said first grooved roller by first and second bracket sidewalls.

11. The deep sea fishing rod according to claim 10 wherein said swivel insert includes a means for securing to said rod through frictional engagement of said swivel insert, whereby said swivel insert is allowed to freely rotate but requires forcible removal for disassembly from said rod.

12. The deep sea fishing rod according to claim 10 wherein said first grooved roller includes a first tab formed perpendicular to an edge of a first side wall and extending over said grooved roller, a second tab formed perpendicular to an edge of a second side wall and extending over said grooved roller, said first tab offset is spaced apart from said second tab whereby a fishing line can be placed onto said grooved roller.

13. The deep sea fishing rod according to claim 10 wherein said second grooved roller includes a first bracket tab formed perpendicular to an edge of said bracket first side wall, a second bracket tab formed perpendicular to an edge of a bracket second side wall, said first bracket tab is offset and spaced apart from said second bracket tab whereby a fishing line can be placed onto said second grooved roller.

14. The deep sea fishing rod according to claim 10 wherein said second grooved roller is rotatably secured to said bracket first side wall whereby said second grooved roller can be removed without disassembly of said second bracket side wall.

15. A deep sea fishing rod and reel comprising:
a reel butt adapted for holding a fishing reel;
a first elongated member having a proximal end, a distal end and a length therebetween;
a second elongated member having proximal end, a distal end and a length therebetween;
said proximal ends of said elongated members connected to said reel butt, said distal end of said first elongated member connected to said distal end of said second elongated member, said lengths between said first and second elongated members spaced apart;
a fishing guide means positioned at said distal end of said elongated members for directional placement of a fishing line between said proximal end and said distal end of said elongated member;
a reel main body secured to said rod butt, said reel body having a spool drive shaft;
a cantilevered spool rotatably secured to said spool drive shaft, said cantilevered spool having an inner surface and an outer surface, said inner surface sized to receive at least one digit of a human hand to permit manual braking through frictional engagement, said outer surface of said cantilevered spool adapted to receive a fish line thereon;
wherein said cantilevered spool is rotatably secured to said reel main body allowing spool removal without disassembly of the fish line.

16. The deep sea fishing reel according to claim 15 wherein said spool drive shaft is coupled to a drive gear, said drive gear having a first set of engaging springs sized to permit light drag to allow free spooling, and a second set of engaging springs for fish hauling, said first set of engaging springs induce a light drag and said second set of engaging springs induce a heavy drag, said second set of engaging springs providing secondary engagement to said first set of engaging springs.

17. The deep sea fishing reel according to claim 15 including a cantilevered level winder means providing directional positioning of fishing line on said outer surface of said cantilevered spool.

18. The deep sea fishing reel according to claim 15 wherein said spool drive shaft can be rotated by use of an electric drive motor means.

19. The fishing rod according to claim 15 wherein each said elongated member is wishbone shaped having a distal end having a first width and a distal end having a second width, said first width wider than said second width.

20. The fishing rod according to claim 19 wherein each said elongated member is substantially flat.

21. The fishing rod according to claim 15 wherein said fishing line guide means is a swivel insert for coupling to said distal end of said elongated members, said swivel insert having a first grooved roller secured to said swivel insert, said first grooved roller for receiving of a fishing line from said fishing rod to rotate about an axis substantially perpendicular to said fishing rod; and a second grooved roller secured to said swivel insert and spaced apart from said first grooved roller by a first and second bracket sidewalls.

22. The deep sea fishing rod according to claim 21 wherein said first grooved roller includes a first tab coupled perpendicular to an edge of a first side wall and extending over said grooved roller, a second tab coupled perpendicular to an edge of a second side wall and extending over said grooved roller, said first tab offset is spaced apart from said second tab whereby a fishing line can be placed onto said grooved roller.

23. The deep sea fishing rod according to claim 21 wherein said second grooved roller includes a first bracket tab coupled perpendicular to an edge of said bracket first side wall, a second bracket tab coupled perpendicular to an edge of a bracket second side wall, said first bracket tab is offset and spaced apart from said second bracket tab whereby a fishing line can be placed onto said second grooved roller.

24. The deep sea fishing rod according to claim 10 wherein said second grooved roller is rotatably secured to said bracket first side wall whereby said second grooved roller can be removed without disassembly of said second bracket side wall.

25. The deep sea fishing rod according to claim 10 including a counter means for calculating fishing line length deployment.
